(19) United States
(12) Patent Application Publication
(10) Pub. No.: US 2019/0075627 A1
(43) Pub. Date: Mar. 7, 2019

(54) Illumination Device

(71) Applicant: Bayerische Motoren Werke Aktiengesellschaft, Muenchen (DE)

(72) Inventors: Robert ISELE, Fuerstenfeldbruck (DE); Juergen BRUEGL, Muenchen (DE); Florian ALTINGER, Shenyang/Heping District (CN)

(21) Appl. No.: 16/178,977

(22) Filed: Nov. 2, 2018

Related U.S. Application Data
(63) Continuation of application No. PCT/EP2017/059750, filed on Apr. 25, 2017.

(30) Foreign Application Priority Data
May 4, 2016 (DE) 10 2016 207 728.7

(51) Int. Cl. H05B 33/08

(52) U.S. Cl. CPC H05B 33/086

(57) ABSTRACT

An illumination device for a motor vehicle includes one or more multi-color LED units which each have a settable brightness and a settable color point. Each multi-color LED unit is an individual semiconductor component having multiple single-color LEDs of different colors and a microcontroller. The single-color LEDs and the microcontroller are surrounded by a housing of the semiconductor component. A temperature sensor which measures a current temperature value of the associated multi-color LED unit and supplies this value to the microcontroller is integrated in the semiconductor component. The microcontroller is designed to control an associated multi-color LED unit depending on the current temperature value of the associated multi-color LED unit.

### CROSS REFERENCE TO RELATED APPLICATIONS

This application is a continuation of PCT International Application No. PCT/EP2017/059750, filed Apr. 25, 2017, which claims priority under 35 U.S.C. § 119 from German Patent Application No. 10 2016 207 728.7, filed May 4, 2016, the entire disclosures of which are herein expressly incorporated by reference.

This application contains subject matter related to U.S. application Ser. No. ______, (Attorney Docket No. 080437.PB347US) and U.S. application Ser. No. ______, (Attorney Docket No. 080437.PB349US) both entitled “Illumination Device” and filed on even date herewith.

### BACKGROUND AND SUMMARY OF THE INVENTION

The invention relates to an illumination device, in particular for a motor vehicle.

It is known in the prior art to use multi-color LED units for illumination devices in motor vehicles. These LED units comprise a plurality of single-color LEDs and are generally controlled by LED drivers to vary the brightness and the color point (e.g. the mixed color). Used to this end is a module having a microprocessor that communicates with a motor vehicle databus and additionally drives the LED units, typically via PWM outputs. A suitable motor vehicle databus used frequently here is what is known as a LIN bus (LIN=local interconnect network).

Furthermore, novel multi-color LED units that have an integrated circuit are known from the prior art. In these LED units, the single-color LEDs and the integrated circuit are accommodated in a common package, as a result of which a high packing density can be achieved. The individual LED units are controlled via a data stream.

Until now, parameterizations, required in illumination devices with multi-color LED units for operating the individual LED units, are stored in a central processing module. This has the disadvantage that locally varying operating conditions of the individual LED units can be only insufficiently compensated, which can result in a non-uniform appearance of the illumination device.

The document WO 2014/067830 A1 discloses a method and an arrangement for controlling LEDs in a temperature-corrected manner using look-up tables. In this case, a look-up table which stores the operating current for each LED channel in dependence on temperature is provided in an LED module comprising a plurality of LED channels for each target color point which can be reached by the LED module. The current temperature is measured using a thermistor outside the LED module.

It is the object of the invention to provide an illumination device of at least one multi-color LED unit with improved temperature-dependent operational control.

This object is achieved by way of the illumination device according to claim 1. Developments of the invention are defined in the dependent claims.

The illumination device according to the invention is preferably provided for a motor vehicle, such as a passenger car and possibly also a truck. The illumination device comprises one or more multi-color LED units which each have a settable color point and a settable brightness (i.e. light intensity). The term color point is well known to a person skilled in the art and describes the mixed color produced by the respective multi-color LED unit. The color point can be given for example as a point in a chromaticity diagram, in particular in a chromaticity diagram of the CIE color space.

In the illumination device according to the invention, each multi-color LED unit is an individual semiconductor device having a plurality of, and preferably at least three, single-color LEDs of different colors. The individual semiconductor device furthermore comprises a microcontroller. The single-color LEDs and the microcontroller are enclosed by a package of the semiconductor device, i.e. they are accommodated in a common package of the semiconductor device. According to the invention, a temperature sensor is integrated in the semiconductor device of a respective multi-color LED unit, which temperature sensor measures an instantaneous (that is to say currently available) temperature value of the respective multi-color LED unit and makes it available to the microcontroller. To this end, the microcontroller is set up to control a respective multi-color LED unit in dependence on the instantaneous temperature value of the respective multi-color LED unit.

The illumination device according to the invention has the advantage that, as a result of a temperature sensor being directly integrated in the respective multi-color LED unit, the temperature of the latter can be captured in a highly accurate manner and temperature-dependent operational control can therefore be better adapted to the instantaneous environmental conditions of the respective multi-color LED unit. The temperature measurement of the temperature sensor may be based in this case on technologies which are known per se. For example, the temperature sensor can capture the temperature using a resistance measurement or using infrared or a diode.

In a particularly preferred embodiment, the microcontroller of a respective multi-color LED unit is set up to control each single-color LED of the respective multi-color LED unit in dependence on the instantaneous temperature value of the respective multi-color LED unit, such that a set color point and a set brightness can be kept constant during operation of the respective multi-color LED unit. This makes it possible to set a desired brightness and a desired color point individually and in a highly accurate manner taking into account local temperatures of the individual multi-color LED units, as a result of which a continuously uniform appearance of the illumination device is achieved.

In a preferred variant, the microcontroller of at least some of the multi-color LED units is set up to control each single-color LED on the basis of the control of the operating current of the respective single-color LED, for example using pulse width modulation.

In a further preferred variant of the illumination device according to the invention, the microcontroller of at least some of the multi-color LED units is configured such that, if the instantaneous temperature value exceeds a specified threshold, it reduces the brightness of the respective multi-color LED unit (i.e. the multi-color LED unit to which the microcontroller belongs). This ensures that the multi-color LED unit is not damaged due to excessive temperatures. In this context, a specification may be preferably made according to which the brightness of the multi-color LED unit is decreased more strongly the more the specified threshold is exceeded. If needed, the brightness of the multi-color LED unit can also be lowered to zero, i.e. the corresponding multi-color LED unit can be switched off. This can be achieved for example by way of a second threshold that is higher than the specified threshold. If the instantaneous temperature exceeds this second threshold, the multi-color LED unit will be switched off.

In a particularly preferred embodiment, the illumination device according to the invention comprises a plurality of multi-color LED units, which are connected to an internal databus (i.e. a databus within the illumination device). This internal databus in turn is coupled to a processing module, wherein the processing module is set up to pass internal control commands for setting the brightness and the color point of the individual multi-color LED units to the internal databus. The above processing module is preferably set up to receive external control commands from a motor vehicle databus and convert them to the above internal control commands.

In the embodiment that was just described, simple control of the individual multi-color LED units via an internal databus is achieved. The internal databus can be e.g. an SPI databus (SPI=serial protocol interface) or possibly even a different databus, such as e.g. a differential databus, which codes digital data between two lines via a voltage difference. The above motor vehicle databus can be, for example, a LIN bus (LIN=local interconnect network) or a CAN bus (CAN=controller area network).

In a further preferred embodiment, at least some of the multi-color LED units comprise one or more RGB-LED units and/or RGBW-LED units. In a manner that is known per se, an RGB-LED unit comprises a red, green and blue single-color LED, and an RGBW-LED unit comprises, in addition to a red, green and blue LED, a white light LED.

In a particularly preferred embodiment, the illumination device is an interior illumination means in a motor vehicle or possibly an exterior illumination means on the outside of the motor vehicle. Hereby, pleasing light effects with a homogeneous appearance can be generated.

In addition to the above-described illumination device, the invention relates to a motor vehicle, in particular to a passenger car or possibly also a truck, which comprises one or more of the illumination devices according to the invention or of preferred variants of said illumination devices.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of an embodiment of an illumination device according to the invention.

FIG. 2 shows a detailed view of an LED unit from FIG. 1.

### DETAILED DESCRIPTION OF THE DRAWINGS

One embodiment of the invention will be described below with reference to an illumination device that is installed in a motor vehicle in the form of interior illumination and comprises, as the light-emitting means, a multiplicity of multi-color LED units 3, which are arranged on a strip. These multi-color LED units, which will also be referred to below simply as LED units, in each case represent an individual semiconductor device having a plurality of single-color LEDs 301 to 304 and a microcontroller 4. The single-color LEDs and the microcontroller and the temperature sensor described further below are integrated in a common package of the semiconductor device. The single-color LED 301 is a red LED, the single-color LED 302 is a green LED, the single-color LED 303 is a blue LED, and the single-color LED 304 is a white LED. With the LED units which are arranged in the manner of a strip, it is possible to achieve very high packing density (from 144 to 367 LEDs/m, depending on the type of package).

The individual LED units 3 are controlled via a digital data stream in the form of a bitstream, which is passed on to the individual LED units using an internal databus 2 (i.e. a databus that is provided internally in the illumination device). The internal databus comprises a line CL for the cycle and a line DL for the bitstream.

The signals on the internal databus 2 originate from a processing module 1, which is coupled to a LIN bus 6 of the motor vehicle. The processing module comprises a LIN transceiver 101, which taps corresponding digital signals from the LIN bus 6 for controlling the LED units 3, and a microprocessor 102, which converts the tapped signals to corresponding data signals on the data line DL. The signals that have been passed on along the LIN bus 6 comprise signals which are intended for the illumination device and define a light pattern that is to be set for the illumination device. These signals in turn originate from a controller of the motor vehicle, which defines, for example on the basis of an input by the driver, the light pattern to be generated and passes it to the LIN bus as a corresponding signal. Via the processing module 1, it is recognized whether the light pattern is provided according to the current signal on the LIN bus 6 for the illumination device. If this is the case, this signal is converted to a corresponding signal for the internal databus 2 using the microprocessor 102.

The internal databus 2 can here be an SPI bus, for example. The signals for the SPI bus are preferably produced here by the microprocessor 102 by way of software SPI. Software SPI is known per se from the prior art and represents a program library with which any free pins of the microprocessor 102 can be used to output signals to the SPI bus. Alternatively, it is possible to use hardware SPI. In this case, special SPI pins for the output of signals to the SPI bus are provided. The use of software SPI has the advantage that, in the internal databus 2, a plurality of lines DL and CL for controlling a relatively large number of LED units 3 may be provided. As an alternative to an SPI bus, the internal databus can also be configured as a differential databus or as any other desired databus. A differential databus is characterized in that it codes digital data via a voltage difference between two lines.

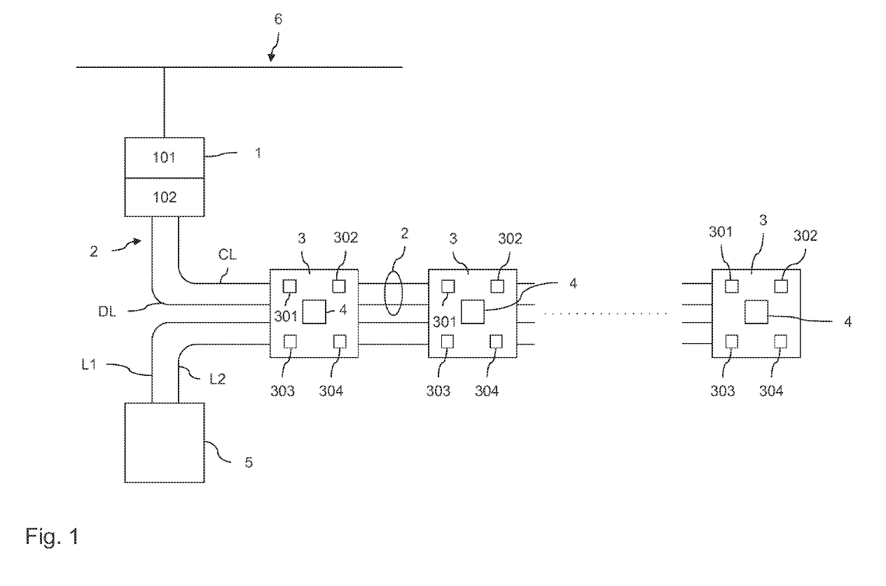

In the embodiment of FIG. 1, in addition to the lines CL and DL, two current lines L1 and L2 are provided, which are connected to a DC voltage supply 5. Based on the bitstream received by the data line DL, a PWM modulation of the current which is supplied to the individual LEDs 301 to 304 is performed in order to control hereby the LEDs in accordance with the bitstream on the data line DL.

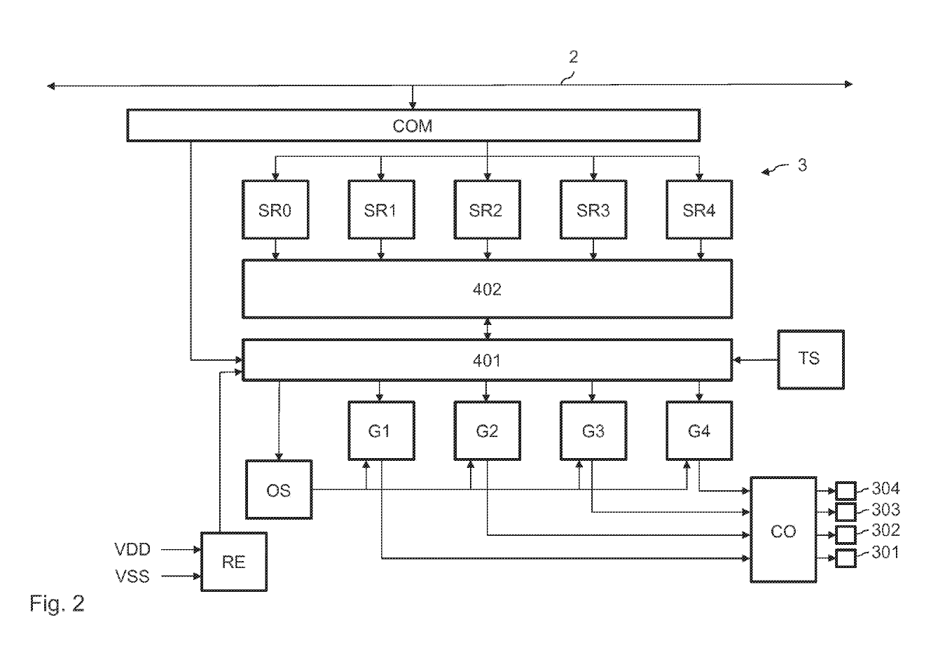

The setup of an individual LED unit 3 from FIG. 1 is shown in detail in FIG. 2. All components of the LED unit shown are integrated here in a single semiconductor device. The signals of the databus 2 are received by a communication interface COM of the LED unit 3. The cycle signal of the cycle line CL is passed on to the microprocessor 401 (described further below), whereas the data stream is passed to the data line DL after decoding in the communication interface COM on 8-bit shift registers SR0, SR1, SR2, SR3 and SR4. The value output by the shift register SR0 here shows the desired total brightness of the LED unit, whereas the color components of the individual single-color LEDs are output for producing the desired mixed color via the values of the shift registers SR1 to SR4. In particular, the color component of the red LED 301 is output by the shift register SR1, the color component of the green LED 302 is output via the shift register SR2, the color component of the blue LED 303 is output by the shift register SR3, and the color component of the white LED 304 is output by the shift register SR4.

The values of the individual shift registers are fed to the microcontroller 4, which consists of a logic or a microprocessor 401 and an associated non-volatile EEPROM memory 402. Saved in this memory are, inter alia, calibration data, which originate from a calibration process of the LED unit and define for a specified standard temperature value of the LED unit how the operating currents of the individual single-color LEDs are to be set so that the total brightness value originating from the shift register SR0 and the color mixture (i.e. the color point in this respect) according to the values from the shift registers SR1 to SR4 are achieved.

The microprocessor 401 resorts to the values stored in the memory 402 and also receives the instantaneous temperature value from a temperature sensor TS which is integrated in the semiconductor device of the LED unit. In this case, the microprocessor stores a temperature algorithm which determines the corresponding operating currents for the above-mentioned standard temperature value by accessing the memory 402 and suitably corrects these operating currents if the instantaneous temperature value originating from the temperature sensor TS differs from the standard temperature value. In this case, the correction is such that the desired brightness and the desired color point in accordance with the values from the shift registers are also correctly set in the case of temperature variations.

The temperature algorithm of the microprocessor 401 therefore takes into account the fact that the temperature of the LED unit 3 affects the operation of the latter, with the result that a temperature-dependent correction must be carried out in order to achieve a desired brightness and a desired color point. This correction is carried out on the basis of a temperature value which is directly determined in the LED unit using a temperature sensor integrated therein. This ensures a particularly exact temperature measurement at the location of the LED unit. In addition, the temperature compensation algorithm is stored in a microcontroller which is part of the semiconductor device of an LED unit. This makes it possible to adapt the operation of the individual multi-color LED units in an illumination device to the instantaneous temperature individually and in a very accurate manner.

The operating currents for the individual LEDs 301 to 304 are provided via a voltage regulator RE, which receives the positive voltage VDD and the negative voltage VSS from the voltage supply 5 shown in FIG. 1. The microprocessor 401 furthermore generates a cycle for a corresponding oscillator OS, which is passed on to PWM generators G1, G2, G3 and G4. The operating currents of the individual LEDs 301 to 304 are produced in the generators G1 to G4 via pulse width modulation. The values of the operating currents originating from the temperature compensation algorithm are passed on to the individual generators G1 to G4 from the microprocessor 401. The generator G1 produces the current for the red LED 301 using pulse width modulation, the generator G2 produces the current for the green LED 302, the generator G3 produces the current for the blue LED 303, and the generator G4 produces the current for the white LED 304. Via the PWM signals generated by the individual generators, which reach the single-color LEDs via the current output CO, the corresponding light is then set with the desired brightness and the desired color point for the LED unit 3 in accordance with the signal which reaches the LED unit via the internal databus 2.

The embodiments of the invention which are described above have a number of advantages. In particular, within the scope of temperature compensation, the instantaneous temperature value required for this purpose is determined in a very exact manner using a temperature sensor which is integrated in the semiconductor device of a respective multi-color LED unit. The temperature value is therefore determined in a highly accurate manner at the location of the respective multi-color LED unit. In addition, the temperature compensation algorithm is integrated in the semiconductor device of the respective multi-color LED unit. In other words, integrated logic in a multi-color LED module is used to implement temperature compensation. This makes it possible to set the desired brightness and the desired color point for each LED unit individually and in a highly accurate manner in dependence on the temperature at the installation location of the respective LED unit. This makes it possible to ensure a uniform appearance of the LED unit or of an LED strip comprising many LED units over the entire service life.

### LIST OF REFERENCE SIGNS

1 processing module
101 LIN transceiver
102 microprocessor
2 internal databus
3 multi-color LED units
301, 302, 303, 304 single-color LEDs
4 microcontroller
401 microprocessor
402 EEPROM
5 voltage supply
6 motor vehicle databus
CL line for cycle signal
DL data line
L1, L2 current lines
COM communication interface
SR0, SR1, SR2, SR3, SR4 shift registers
TS temperature sensor
G1, G2, G3, G4 PWM generators
OS oscillator
RE voltage regulator
VDD, VSS voltages
CO current output

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An illumination device, comprising:
one or more multi-color LED units which each have a settable brightness and a settable color point, wherein each multi-color LED unit is an individual semiconductor device with multiple single-color LEDs of different colors and a microcontroller,
wherein the single-color LEDs and the microcontroller are enclosed by a package of the semiconductor device,
wherein a temperature sensor is integrated in the semiconductor device, which temperature sensor measures an instantaneous temperature value of the respective multi-color LED unit and makes it available to the microcontroller, and
wherein the microcontroller is configured to control a respective multi-color LED unit in dependence on the instantaneous temperature value of the respective multi-color LED unit.

2. The illumination device as claimed in claim 1, wherein
the microcontroller of a respective multi-color LED unit is configured to control each single-color LED of the respective multi-color LED unit in dependence on the instantaneous temperature value of the respective multi-color LED unit, such that a set color point and a set brightness are kept constant during operation of the respective multi-color LED unit.

3. The illumination device as claimed in claim 1, wherein
the microcontroller of at least some of the multi-color LED units is configured to control each single-color LED on the basis of control of an operating current of the respective single-color LED.

4. The illumination device as claimed in claim 1, wherein
the microcontroller of at least some of the multi-color LED units is configured such that, if the instantaneous temperature value exceeds a specified threshold, it reduces the brightness of the multi-color LED unit.

5. The illumination device as claimed in claim 1, wherein
the illumination device comprises a plurality of multi-color LED units, which are connected to an internal databus, which is coupled to a processing module, and
the processing module is configured to pass internal control commands for setting the brightness and the color point of the individual multi-color LED units to the internal databus.

6. The illumination device as claimed in claim 5, wherein
the processing module is configured to receive external control commands from a motor vehicle databus and convert said commands to the internal control commands.

7. The illumination device as claimed in claim 1, wherein
at least some of the multi-color LED units comprise one or more RGB-LED units and/or RGBW-LED units.

8. The illumination device as claimed in claim 1, wherein
the illumination device is an interior illumination device in a motor vehicle or an exterior illumination device on an exterior of the motor vehicle.

9. A motor vehicle, comprising one or more illumination devices as claimed in claim 1.
